(19) United States
(12) Patent Application Publication
(10) Pub. No.: US 2012/0077050 A1
(43) Pub. Date: Mar. 29, 2012

(54) Award trophy

(76) Inventor: John Banman, Corona, CA (US)

(21) Appl. No.: 12/924,527

(22) Filed: Sep. 29, 2010

(51) Int. Cl. G09F 19/00

(52) U.S. Cl. 428/542.4

(57) ABSTRACT

A novel award trophy that includes a supporting base, a riser member superimposed over the supporting base, a first uniquely configured connector member having a plurality of securement legs for inter-connecting the riser member with the supporting base, a trophy superimposed over the riser member and a second uniquely configured connector member having a plurality of securement legs for inter-connecting the trophy with the riser member.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to achievement awards. More particularly, the invention concerns a novel award trophy that includes a supporting base, a riser member carried by the supporting base, a display support member carried by the riser member and disposed in a generally horizontal plane and display member for displaying award indicia connected to the periphery of the display support member and extending generally perpendicular relative thereto.

2. Description of Related Art Including Information Disclosed Under 37 CFR 1.97 and 1.98

Achievement awards of various types are frequently given to individuals and athletic teams for outstanding achievements in sports such as golf, bowling, tennis, baseball, basketball and the like. These awards include medals, plaques and a number of different types of small statues of which frequently take the form of a decorative member of an appropriate design that is mounted on a supporting base.

Exemplary of one type of achievement award is that described in U.S. Pat. No. 5,834,073 issued to Greenblat and the present inventor. This latter patent discloses an achievement award which comprises a substantially transparent, injection molded acrylic plaque, and a supporting base. The transparent plaque has a decorative design or image, which appears to be embedded in the central portion of the plaque. The central portion of the plaque includes a front face and a rear face wherein the fossil-like image is formed in the rear face. At the base of the central portion is a three-dimensional insert which is also injection molded. This insert connects the central portion to the base.

Another type of achievement award is described in U.S. Pat. No. 6,828,034 issued to the present inventor. This latter patent discloses an award construction that includes a decorative member, a supporting base for supporting the decorative member and an alternate means for interconnecting the decorative member with the supporting base. More particularly, in one form of the invention the base portion of the decorative member includes a peripheral portion having a locking rim that can be lockably interconnected with a yieldably deformable locking assembly that is affixed to and extends upwardly from the upper surface of the supporting base. In another form of the invention, the identical base portion of the decorative member can be interconnected with the support base by means of a threaded rod which is threadably received within a threaded bore formed in the base portion of the decorative member.

### BRIEF SUMMARY OF THE INVENTION

It is an object of the present invention to provide a novel award trophy construction that includes a supporting base, a riser member carried by the supporting base, a display support member of novel construction carried by the riser member and disposed in a generally horizontal plane and display member of novel construction connected to the periphery of the display support member and extending generally perpendicular with respect thereto.

Another object of the invention is to provide a trophy or award construction of the aforementioned character that has several alternate configurations. For example, in one form of the invention the riser member is circular in cross-section and the display support member that is uniquely designed to interconnect the display member with the award and the display member itself are also circular. In another form of the invention, the riser member is oval in cross-section and the display support member that is uniquely designed to interconnect the display member with the award and the display member itself are also oval. In still another form of the invention, the riser member is rectangular in cross-section and the display support member and the display member itself are also rectangular.

Another object of the invention is to provide an award trophy construction of the character described in the preceding paragraphs in which the display support member that functions to support the display member, and the display member itself, are of a unique fanciful design.

Another object of the invention is to provide an award trophy construction of the class described in which the display member includes a planar surface to which a decorative, adhesive stamp can be affixed

These and other objects of the invention will be realized from the apparatus illustrated in the drawings and described in the paragraphs that follow.

### BRIEF DESCRIPTION OF SEVERAL VIEWS OF THE DRAWINGS

FIG. 1 is a generally perspective, exploded view of one form of the award trophy of the present invention.

FIG. 2 is a generally perspective, exploded view of the award trophy shown in FIG. 1.

FIG. 3 is an enlarged side elevational, exploded view, partly in cross-section of the award trophy shown in FIG. 2.

FIG. 3A is a generally perspective, exploded view of an alternate form of the award trophy of the present invention.

FIG. 3B is generally perspective, exploded view of another form of the award trophy of the present invention.

FIG. 4 is a generally perspective, exploded view of still another form of the award trophy of the present invention.

FIG. 4A is a generally perspective exploded view of yet another form of the award trophy of the present invention.

FIG. 4B is a generally perspective exploded view of still another form of the award trophy of the present invention.

FIG. 5 is a generally perspective exploded view of another form of the award trophy of the present invention.

FIG. 6 is a generally perspective exploded view of still another form of the award trophy of the present invention.

FIG. 6A is a generally perspective exploded view of yet another form of the award trophy of the present invention.

### DETAILED DESCRIPTION OF THE INVENTION

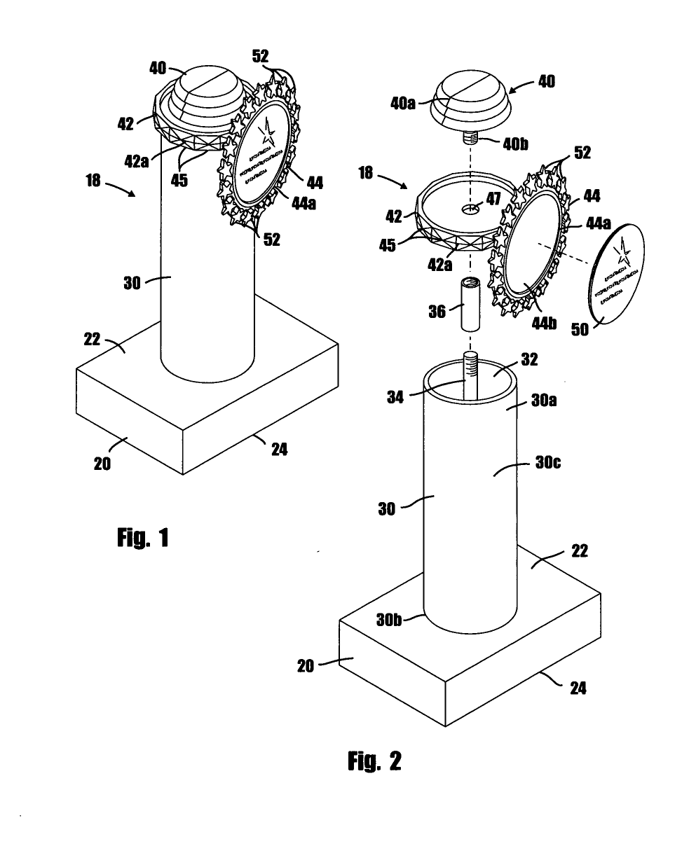

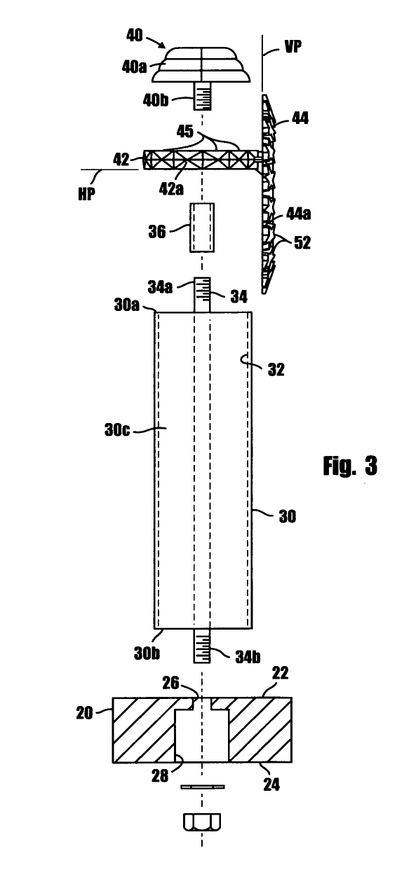

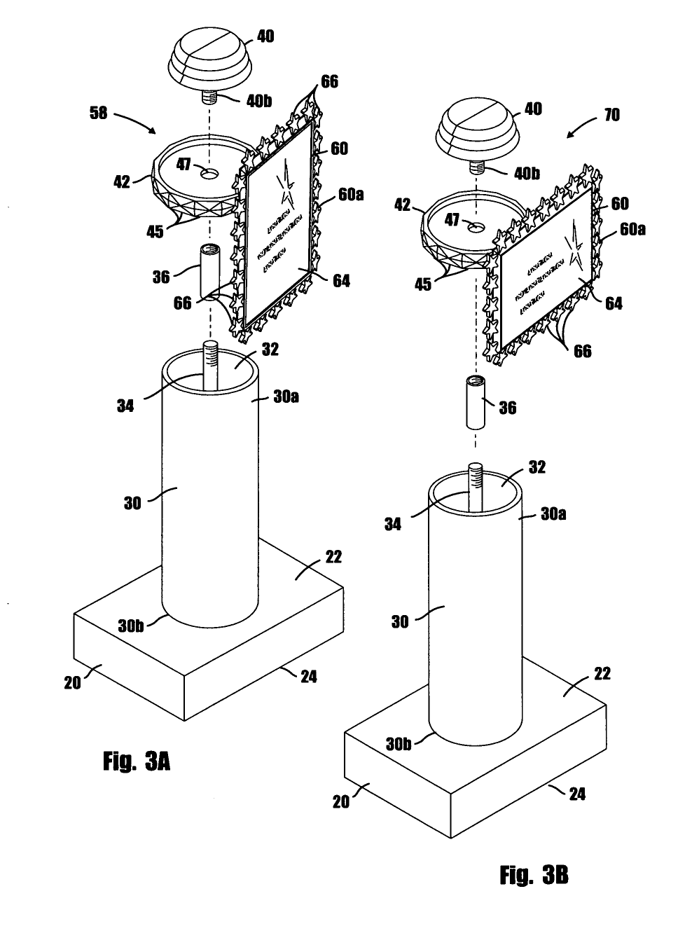

Referring to the drawings and particularly to FIGS. 1 through 3, one form of the award trophy of the present invention is there shown and generally designated by the numeral 18. In this form of the invention the award trophy comprises a supporting base 20 having an upper surface 22, a lower surface 24, a central bore 26 and a counter bore 28 (FIG. 3). Superimposed over and resting on the upper surface 22 of the base, is a riser member 30. Riser member 30 has an upper portion 30a, a lower portion 30b and a side wall 30c, defining an interior space 32.

Connected to base 20 and extending through interior space 32 of riser member 30 is a threaded rod 34. As best seen in FIG. 3 of the drawings, threaded rod 34 has a first threaded end 34a and a second threaded end 34b that is receivable within the central bore 26 of the supporting base. For a purpose presently to be described, an internally threaded coupler 36 is connected to the threaded end 34a of the threaded rod.

Also connected to threaded coupler 36 is a connector member 40. Connector member 40 has a body portion 40a and an externally threaded shaft 40b that extends downwardly from the body portion 40a.

Positioned between connector member 40 and riser member 30 is the important display support member 42 of the invention that functions to support the display member 44 of the invention. Display support member 42, which is disposed within a first, generally horizontal plane “HP” (FIG. 3), is located between connector member 40 and the upper portion of the threaded coupler 36. As best seen in FIGS. 1 and 2 of the drawings, display support member 42 has a peripheral portion 42a that is provided with a multiplicity of circumferentially spaced decorative facets 45. Display support member 42 is also provided with a central aperture 47 for receiving the threaded shaft portion 40b of the connector member 44 (FIG. 2). Display support member 42 and display member 44 comprise a portion of the display assembly 48 of the invention for displaying award indicia of various types.

As illustrated in FIG. 3 of the drawings, display member 44 is connected to the peripheral portion 42a of the display support member and is disposed within a second, generally vertical plane “VP” that is generally perpendicular to the first plane, within which the display support member is located. As best seen in FIGS. 1 and 2 of the drawings, display member 44 has a peripheral portion 44a and a generally planar, central display portion 44b. Affixed to the central display portion 44b and forming a part of the display assembly 48 of the invention, is an indicia-carrying member 50, here provided in the form of an adhesive backed stamp. In the present form of the invention the peripheral portion 44a of the display member is provided with a multiplicity of circumferential spaced decorative elements 52, here shown as five point stars.

In the form of the award trophy of the invention shown in FIGS. 1 through 3 of the drawings, the peripheral portion 44a of display support member is curved as is the side wall 30 of the riser member 28. More particularly, the peripheral portion 44a of display support member is round and the riser member 28 is round in cross-section.

In assembling the award trophy of the present form of the invention with the component parts, the device in the configuration shown in FIG. 3 of the drawings, the first step in the assembly process is to insert the second threaded end 34b of the threaded rod into the central bore 26 of the supporting base 20. Next, the threaded rod is secured to the supporting base by means of the threaded nut 53. This done, the internally threaded coupler 36 is connected to the threaded end 34a of the threaded rod. Next, the riser 30 is positioned over the assemblage made up of a threaded rod and the coupler so that the bottom of the riser rests on the upper surface 22 of the base 20. The display assembly 48 which is made up of the display support member 42, the display member 44 and the indicia carrying member 50, is then positioned over the riser. This done, the threaded shank portion 40b of the connector member 40 is inserted through the central aperture 47 formed in the display support member and is mated with the internally threaded coupler. Rotation of the connector member 40 will then securely interconnect the display assembly 48 with the riser 30. With the assembly thusly completed, the component parts of the award trophy are securely interconnected to form the award trophy depicted in FIG. 1 of the drawings.

Referring to FIG. 3A of the drawings, an alternate form of the award trophy of the invention is there shown and generally designated by the numeral 58. This alternate form of the invention is similar in many respects to that shown in FIGS. 1 through 3 and like numerals are used in FIG. 3A to identify like components. More particularly, in this latest form of the invention, the base 22, the riser member 30, the threaded rod 34, the internally threaded coupler 36, the connector member 40 and the display support member 42 are of substantially identical construction and operation to those previously described. The primary difference between this latest form of the invention and the earlier form of the invention shown in FIGS. 1 through 3 concerns the configuration of the display member which is here designated by the numeral 60. Display member 60, rather than being circular, is rectangular in configuration. As in the earlier described embodiment of the invention, display support member 42 is disposed within a first, generally horizontal plane, and is located between connector member 40 and the upper portion of the threaded coupler 36. Display member 60 is connected to the peripheral portion 42a of the display support member and is disposed in a portrait configuration and within a second, generally vertical plane that is generally perpendicular to the first plane within which the display support member 42 is located. As indicated in FIG. 3A, display member 60 has a peripheral portion 60a and a generally planar, central display portion. Affixed to the central display portion and forming a part of the display assembly 62 of this latest form of the invention, is an indicia-carrying member 64, here provided in the form of an adhesive backed stamp. As before, the peripheral portion 60a of the display member is provided with a multiplicity of circumferential spaced decorative elements 66, here shown as five point stars.

Turning next to FIG. 3B of the drawings, still another form of the award trophy of the invention is there shown and generally designated by the numeral 70. This alternate form of the invention is similar in most respects to that shown in FIG. 3A and like numerals are used in FIG. 3B to identify like components. More particularly, this latest form of the invention is substantially identical to the form of the invention shown in FIG. 3A save for the fact that display member 60, which is connected to the peripheral portion 42a of the display support member, is disposed in a landscape configuration.

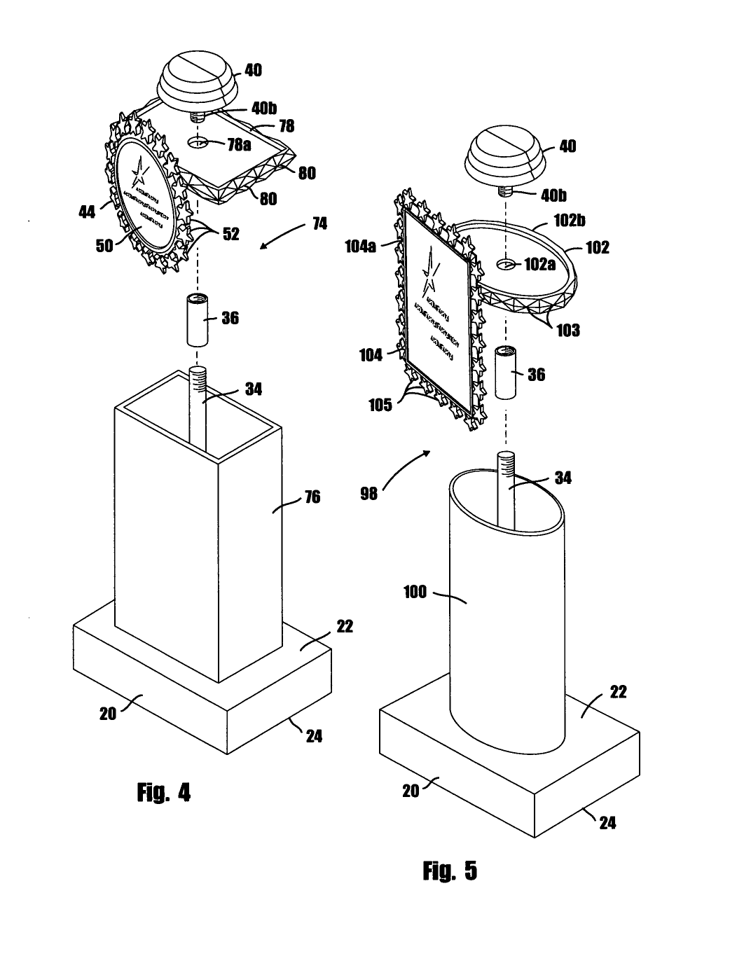

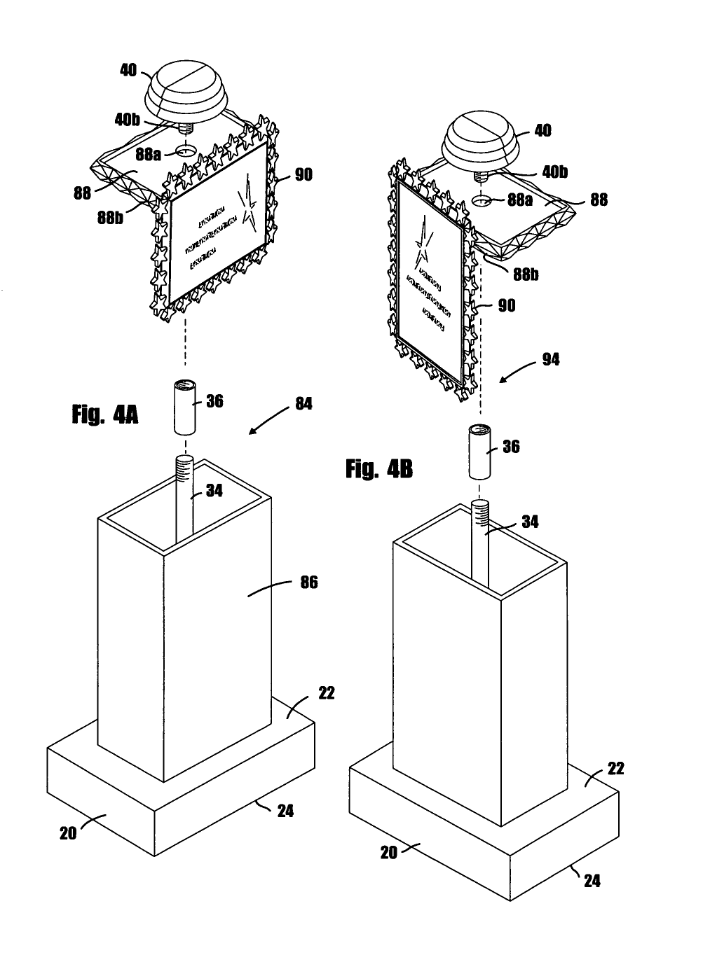

Referring now to FIG. 4 of the drawings, yet another form of the award trophy of the invention is there shown and generally designated by the numeral 74. This alternate form of the invention is also similar in many respects to that shown in FIGS. 1 through 3B of the drawings and like numerals are used in FIG. 4 to identify like components. More particularly, in this latest form of the invention the base 22, the threaded rod 34, the internally threaded coupler 36, the connector member 40, the display member 44 and indicia carrying member 50, are of substantially identical construction and operation to those previously described. The primary difference between this latest form of the invention and the earlier form of the invention shown in FIGS. 1 through 3, concerns the configuration of the riser 76 and the display support member 78, both of which are rectangular in configuration. Display support member 78 is provided with a central aperture 78a that is adapted to receive the threaded shank portion 40b of connector member 40 so that the award trophy of this latest form of the invention can be assembled in the manner previously described.

As in the earlier described embodiment of the invention, display support member 78 is disposed within a first, generally horizontal plane and is located between connector member 40 and the upper portion of the threaded coupler 36. Display member 44 is connected to the peripheral portion 78a of the display support member and is disposed within a second, generally vertical plane that is generally perpendicular to the first plane within which the display support member 78 is located. As indicated in FIG. 4, the peripheral portion 78a of the display support member is provided with a multiplicity of circumferential spaced decorative elements 80, here shown as five point stars.

Considering next FIG. 4A of the drawings, this drawing shows yet another form of the award trophy of the invention which is generally designated by the numeral 84. This latest form of the invention is also similar in many respects to that shown in FIGS. 1 through 3B of the drawings and like numerals are used in FIG. 4 to identify like components. More particularly, in this form of the invention the base 22, the threaded rod 34, the internally threaded coupler 36 and the connector member 40 are of substantially identical construction and operation to those previously described. The primary difference between this latest form of the invention and the earlier forms of the invention, concerns the configuration of the riser 86, which is rectangular in cross-section, and the configuration of the display support member 88 and the display member 90, both of which are rectangular in configuration. Display support member 88 is provided with a central aperture 88a that is adapted to receive the threaded shank portion 40b of connector member 40 so that the award trophy of this latest form of the invention can be assembled in the manner previously described.

As in the earlier described embodiment of the invention, display support member 88 is disposed within a first, generally horizontal plane and is located between connector member 40 and the upper portion of the threaded coupler 36. Rectangular display member 90 is connected to the peripheral portion 88a of the display support member and is disposed within a second, generally vertical plane that is generally perpendicular to the first plane within which the display support member 88 is located. As indicated in FIG. 4A, the peripheral portions of both the display support member and the display member are provided with a multiplicity of circumferential spaced decorative elements shown as five point stars.

The form of the award trophy of the invention shown in FIG. 4B of the drawings, which is generally designated by the numeral 94, is similar in many respects to the award trophy shown in FIG. 4A and like numerals are used in FIG. 4B to identify like components. More particularly, display 94 is substantially identical to the award trophy 84 save for the fact that display member 90, which is connected to the peripheral portion 88a of the display support member, is disposed in a portrait rather than a landscape configuration.

Turning now to FIG. 5 of the drawings, still another form of the award trophy of the invention is there shown and generally designated by the numeral 98. This alternate form of the invention is also similar in many respects to that shown in FIGS. 1 through 3B of the drawings and like numerals are used in FIG. 5 to identify like components. More particularly, in this latest form of the invention the base 22, the threaded rod 34, the internally threaded coupler 36 and the connector member 40 are of substantially identical construction and operation to those previously described. The primary difference between this latest form of the invention and the earlier form of the invention concerns the configuration of the riser 100 and the display support member 102 both of which are oval in configuration. Display support member 102 is provided with a central aperture 102a that is adapted to receive the threaded shank portion 40b of the connector member so that the trophy can be assembled in the manner previously described.

As in the earlier described embodiments of the invention, display support member 102 is disposed within a first, generally horizontal plane and is located between connector member 40 and the upper portion of the threaded coupler 36. Display member 104, which here is rectangular in configuration, is connected to the peripheral portion 102b of the display support member and is disposed within a second, generally vertical plane that is generally perpendicular to the first plane within which the display support member 102 is located. As indicated in FIG. 5, the peripheral portions 102b and 104a of the display support member and a display member are provided with a multiplicity of circumferential spaced decorative elements 103 and 105, here shown as five point stars.

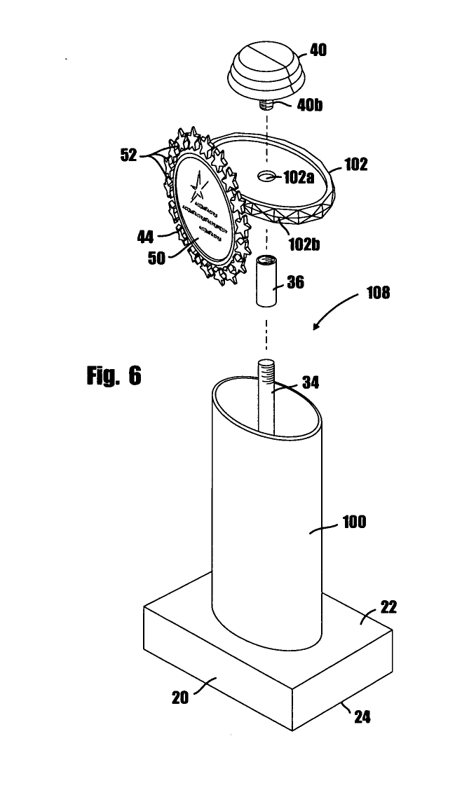

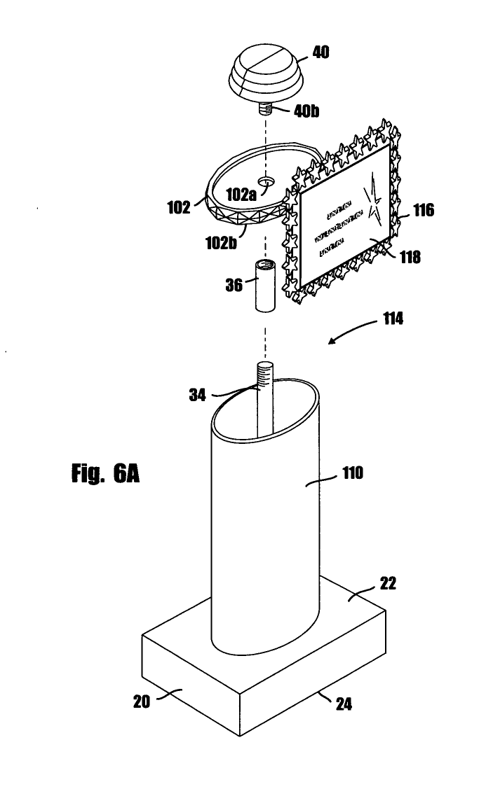

The award trophy of the invention shown in FIG. 6 and generally designated by the numeral 108 is similar in many respects to the award trophy shown in FIG. 5 of the drawings and like numerals are used in FIG. 6 to identify like components. More particularly, in this latest form of the invention the base 22, the threaded rod 34, the internally threaded coupler 36, the connector member 40, the riser 100, and the display support member 102 are of substantially identical construction and operation to those previously described. The primary difference between this latest form of the invention and the earlier form of the invention concerns the configuration of the display member 44, which is of the character shown in FIG. 4 of the drawings and is round rather than rectangular in shape. As in the earlier described embodiments of the invention, display support member 102 is disposed within a first, generally horizontal plane and is located between connector member 40 and the upper portion of the threaded coupler 36. Display member 44 is connected to the peripheral portion 102b of the display support member and is disposed within a second, generally vertical plane that is generally perpendicular to the first plane within which the display support member 102 is located.

The award trophy of the invention shown in FIG. 6A and generally designated by the numeral 114 is similar in many respects to the award trophy shown in FIG. 6 of the drawings and like numerals are used in FIG. 6A to identify like components. More particularly, in this latest form of the invention the base 22, the threaded rod 34, the internally threaded coupler 36, the connector member 40, and the display support member 102 are of substantially identical construction and operation to those previously described. The primary differences between this latest form of the invention and the earlier form of the invention concerns the configuration of the riser 110 which, while still being oval in cross-section, is somewhat longer than riser 100. Additionally, the display member 116 as well as the indicia-carrying member 118 are rectangular in shape rather than being round. As in the earlier described embodiments of the invention, display support member 102 is disposed within a first, generally horizontal plane and is located between connector member 40 and the upper portion of the threaded coupler 36. Display member 116 is connected to the peripheral portion 102b of the display support member and is disposed within a second, generally vertical plane that is generally perpendicular to the first plane within which the display support member 102 is located. Once again, award trophy 114 is assembled in the same manner as previously described.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

1. An award trophy comprising:
(a) a supporting base having an upper surface and a lower surface;
(b) a riser member superimposed over and connected to said base, said riser member having a wall; and
(c) a display assembly carried by said riser member for displaying indicia, said display assembly comprising:
(i) a display support member having a peripheral portion and being disposed within a first plane; and
(ii) a display member connected to said peripheral portion of said display support member, said display member having a peripheral portion and a central display portion and being disposed within a second plane extending angularly with respect to said first plane.

2. The award trophy as defined in claim 1 in which said display assembly further includes an indicia carrying member affixed to said central display portion of said display member.

3. The award trophy as defined in claim 1 in which said periphery of said display support member is curved and in which said wall of said riser member is curved.

4. The award trophy as defined in claim 1 in which said periphery of said display support member is rectangular and in which said riser member is rectangular in cross section.

5. The award trophy as defined in claim 1 in which said periphery of said display support member is curved, in which said wall of said riser member is curved and in which said peripheral portion of said display member is rectangular.

6. The award trophy as defined in claim 1 in which said periphery of said display support member is curved, in which said wall of said riser member is curved and in which said peripheral portion of said display member is curved.

7. The award trophy as defined in claim 1 in which said periphery of said display support member is rectangular, in which said riser member is rectangular in cross section and in which said periphery of said display' member is curved.

8. The award trophy as defined in claim 1 in which said wall of said riser defines an interior space and in which said award trophy further comprises a threaded rod connected to said base and extending through said interior space of said riser, said threaded rod having first and second threaded ends.

9. The award trophy as defined in claim 8 in which said award trophy further comprises:
(a) a threaded coupler connected to said first end of said threaded rod; and
(b) a connector member connected to said threaded coupler said connector member having a body portion and a threaded shaft portion connected to said body portion and extending there from.

11. The award trophy as defined in claim 10 further including a nut threadably connected to said second end of said threaded rod.

12. An award trophy comprising:
(a) a supporting base having an upper surface, a lower surface and a central bore;
(b) a riser superimposed over said base, said riser having a wall defining an interior space;
(c) a threaded rod connected to said base and extending through said interior space of said riser, said threaded rod having a first threaded end and a second threaded end receivable within said central bore of said supporting base;
(d) a threaded coupler connected to said first end of said threaded rod;
(e) a connector member connected to said threaded coupler said connector member having a body portion and a threaded shaft portion connected to said body portion and extending there from; and
(f) a display assembly carried by said carried by said riser for displaying award indicia, said display assembly comprising:
(i) a display support member disposed between said connector member and said riser, said the display support member having a peripheral portion and a central aperture for receiving said threaded shaft portion of said connector member; and
(ii) a display member connected to said display support member, said display member having a peripheral portion and a central display portion.

13. The award trophy as defined in claim 12 in which said display assembly further includes an indicia carrying member affixed to said central display portion of said display member.

14. The award trophy as defined in claim 12 in which said display support member is disposed within a first plane and in which said display member is disposed within a second plane perpendicular to said first plane.

15. The award trophy as defined in claim 12 further including a nut threadably connected to said second end of said threaded rod.

16. The award trophy as defined in claim 12 in which said periphery of said display support member is curved and in which said wall of said riser member is curved.

17. The award trophy as defined in claim 12 in which said periphery of said display support member is rectangular and in which said riser member is rectangular in cross section.

18. An award trophy comprising:
(a) a supporting base having an upper surface, a lower surface and a central bore;
(b) a riser superimposed over said base, said riser having a side wall defining an interior space;
(c) a threaded rod connected to said base and extending through said interior space of said riser, said threaded rod having a first threaded end and a second threaded end receivable within said central bore of said supporting base;
(d) a threaded coupler connected to said first end of said threaded rod;
(e) a connector member connected to said threaded coupler said connector member having a body portion and a threaded shaft portion connected to said body portion and extending there from; and
(f) a display assembly carried by said carried by said riser for displaying award indicia, said display assembly comprising:
(i) a display support member disposed within a first plane and located between said connector member and said riser, said the display support member having a peripheral portion and a central aperture for receiving said threaded shaft portion of said connector member;
(ii) a display member connected to said display support member and being disposed within a second plane perpendicular to said first plane, said display member having a peripheral portion and a central display portion; and
(iii) an indicia carrying member affixed to said central display portion of said display member.

19. The award trophy as defined in claim 18 in which said periphery of said display support member is curved and in which said side wall of said riser member is curved.

20. The award trophy as defined in claim 18 in which said periphery of said display support member is rectangular and in which said riser member is rectangular in cross section.
